(19) United States
(12) Patent Application Publication
(10) Pub. No.: US 2012/0223595 A1
(43) Pub. Date: Sep. 6, 2012

(54) WIRELESS POWER TRANSMISSION APPARATUS

(75) Inventors: Noriaki OODACHI, Kawasaki-shi (JP); Hiroki Shoki, Yokohama-shi (JP); Kenichirou Ogawa, Fuchu-shi (JP); Hiroki Kudo, Kawasaki-shi (JP); Shuichi Obayashi, Yokohama-shi (JP)

(73) Assignee: KABUSHIKI KAISHA TOSHIBA, Tokyo (JP)

(21) Appl. No.: 13/409,565

(22) Filed: Mar. 1, 2012

(30) Foreign Application Priority Data
Mar. 4, 2011 (JP) 2011-048177

(51) Int. Cl. H02J 17/00

(52) U.S. Cl. 307/104

(57) ABSTRACT

According to one embodiment, a wireless power transmission apparatus includes a housing and a plurality of transmitting coils. The housing is capable of containing one or more power receiving apparatuses includes one or more receiving coils which receive power. The plurality of transmitting coils are provided inside the housing and are configured to transmit the power to the power receiving apparatuses by making electromagnetic coupling with the receiving coils, at least two of the plurality of transmitting coils having orientations of axes different from each other, the axes each indicating a line perpendicular to a plane which is defined by windings of a coil.

### CROSS-REFERENCE TO RELATED APPLICATIONS

This application is based upon and claims the benefit of priority from prior Japanese Patent Application No. 2011-048177, filed Mar. 4, 2011, the entire contents of which are incorporated herein by reference.

### FIELD

Embodiments described herein relate generally to a wireless power transmission apparatus.

### BACKGROUND

In recent years, wireless power transmission technology to transmit power in a contactless manner by means of a transmitting coil and a receiving coil has emerged. Orientations of the transmitting and receiving coils are generally important for the wireless power transmission technology, and therefore, positioning of the coils is required.

In a technique which does not require such positioning, a power receiving apparatus is placed in a housing filled with a liquid and power is transmitted to the power receiving apparatus from a power transmitting antenna provided in the housing.

### BRIEF DESCRIPTION OF THE DRAWINGS

FIG. 1A is a perspective view of a wireless power transmission apparatus according to the first embodiment;

FIG. 1B is a plan view thereof along the x-axis;

FIG. 2 illustrates an example of a power receiving apparatus;

FIG. 3 illustrates another example of the power receiving apparatus;

FIG. 4A is a perspective view of a wireless power transmission apparatus where three or more transmitting coils are provided;

FIG. 4B is a plan view thereof along the x-axis;

FIG. 5 illustrates a wireless power transmission apparatus according to the second embodiment;

FIG. 6 is a block diagram illustrating another example of the wireless power transmission apparatus according to the second embodiment;

FIG. 7 illustrates a wireless power transmission apparatus according to the third embodiment;

FIG. 8 is a block diagram illustrating a signal receiving apparatus according to a modification;

FIG. 9 illustrates a wireless power transmission apparatus according to the modification;

FIG. 10 illustrates a wireless power transmission apparatus according to another example of the modification;

FIG. 11 illustrates first exemplary usage of a wireless power transmission apparatus;

FIG. 12 illustrates second exemplary usage of a wireless power transmission apparatus; and

FIG. 13 illustrates third exemplary usage of a wireless power transmission apparatus.

### DETAILED DESCRIPTION

In order to change a position of a power receiving apparatus, a liquid needs to be stirred. Further, the power receiving apparatus is formed of a material which can be places in a liquid is needed.

In general, according to one embodiment, a wireless power transmission apparatus includes a housing and a plurality of transmitting coils. The housing is capable of containing one or more power receiving apparatuses comprising one or more receiving coils which receive power. The plurality of transmitting coils are provided inside the housing and are configured to transmit the power to the power receiving apparatuses by making electromagnetic coupling with the receiving coils, at least two of the plurality of transmitting coils having orientations of the axes different from each other, axes each indicating a line perpendicular to a plane which is defined by windings of a coil.

Hereinafter, a wireless power transmission apparatus according to embodiments will be described with reference to the drawings. In the embodiments below, parts denoted at each common reference symbol operate in the same manner as each other, and reiterative descriptions will be appropriately omitted.

### First Embodiment

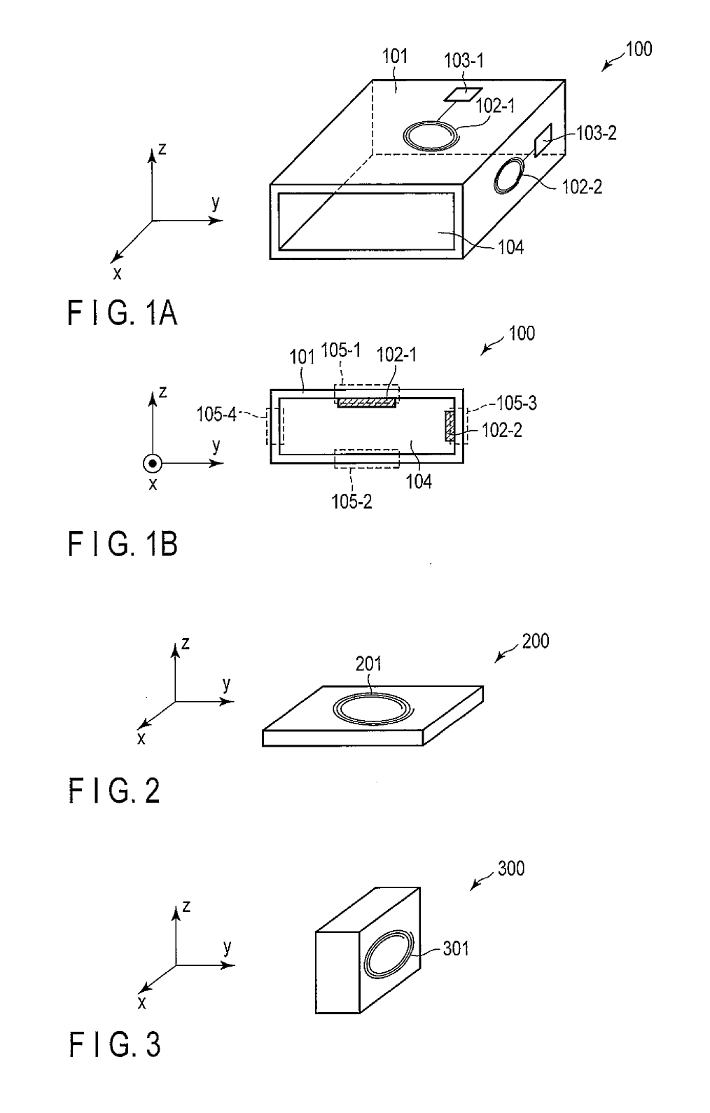

A wireless power transmission apparatus according to the present embodiment will be described with reference to FIGS. 1A and 1B. FIG. 1A is a perspective view of the wireless power transmission apparatus. FIG. 1B is a view of the wireless power transmission apparatus along the x-axis.

A wireless power transmission apparatus 100 according to the present embodiment includes a housing 101, power transmission coils 102, and transmitting circuits 103. Although FIGS. 1A and 1B show an example of providing two transmitting coils 102, the number of transmitting coils is not limited to two but may be two or more.

The housing 101 is formed of, for example, a metal conductor and includes an opening 104 for inserting a power receiving apparatus described later. The housing 101 is desirably all formed of a metal conductor in order to suppress leakage of electromagnetic radiation to the outside from the housing 101.

At least partial areas of the housing 101 need to be formed of a conductive material, wherein the partial areas are close to the transmitting coils 102, in areas where the transmitting coils 102 are assumed to be orthogonally projected, on planes of the housing 101 which intersect projected axes of the transmitting coils 102. The axes are each a line perpendicular to a plane which is defined by the windings of a coil.

Specifically referring to FIG. 1B, areas where transmitting coil 102-1 is orthogonally projected are areas 105-1 and 105-2, on the surfaces of the housing 101 which intersect an extended line of axis of transmitting coil 102-1. Similarly, areas where transmitting coil 102-2 is orthogonally projected are areas 105-3 and 105-4, on the surfaces of the housing 101 which intersect an extended line of axis of transmitting coil 102-2. Among these areas, only at least the areas 105-1 and 105-3 need to be formed of a conductor.

Although the example of FIGS. 1A and 1B show the housing 101 as a cuboid, the housing 101 may have any shape. The example of FIGS. 1A and 1B also show a rectangular opening 104. However, the opening 104 may have any shape and may be designed to match the size of the power receiving apparatus insofar as the power receiving apparatus can be inserted through the shape. The opening 104 may be attached with a cover formed of a metal conductor, which can be opened/closed. The cover formed of the metal conductor can further suppress leakage of electromagnetic radiation to the outside from the housing 101.

The transmitting coils 102 are each wound n times (where n is an integer not smaller than 1), and are provided in a plurality in the housing 101. Further, in the example of FIGS. 1A and 1B, the two transmitting coils 102-1 and 102-2 are positioned on inner surfaces of the housing 101 in a manner that the coil axes of the two coils intersect each other at right angles. The transmitting coils 102 may be either in contact with or apart from the inner surfaces of the housing 101. Specifically, as shown in FIG. 1B, transmitting coil 102-1 is provided on a top surface of the housing 101, and transmitting coil 102-2 is provided on a side surface perpendicular to the top surface. That is, the axis of transmitting coil 102-1 is vertical (z-axis), and the axis of transmitting coil 102-2 is horizontal (y-axis). Thus, the coil axes intersect each other.

Although the transmitting coils 102 each have a cylindrical shape, the coils are not limited to this shape but may have a quadrangular prism shape, a flat spiral shape, or a flat polygonal spiral shape. A magnetic material or sheet may be inserted between the transmitting coils 102 and the metal housing. Power efficiency can be thereby improved.

The transmitting circuits 103 are connected to an external power supply (not shown) and the transmitting coils 102, and receive power from the external power supply. The transmitting circuits 103 convert the power from a low frequency into a high frequency, and supply the converted power to the transmitting coils 102. In the example shown in FIG. 1A, a transmitting circuit 103-1 is connected to transmitting coil 102-1, as well as a transmitting circuit 103-2 to transmitting coil 102-2. Transmitting circuits 103-1 and 103-2 respectively supply transmitting coils 102-1 and 102-2 with power.

Next, examples of power receiving apparatuses will be described with reference to FIGS. 2 and 3.

A power receiving apparatus 200 shown in FIG. 2 includes a receiving coil 201. The receiving coil 201 is provided on a top surface of the power receiving apparatus 200, and has an axis corresponding to the vertical (z-axis).

The power receiving apparatus 300 shown in FIG. 3 also includes a receiving coil 301. The receiving coil 301 is provided on a side surface of the power receiving apparatus 300, and has an axis corresponding to the horizontal (y-axis).

Descriptions will now be made below, supposing that the power receiving apparatus 200 shown in FIGS. 1A and 1B is inserted in the wireless power transmission apparatus 100.

In this case, transmitting coil 102-1 provided on the top surface of the housing 101 in the wireless power transmission apparatus 100 and the receiving coil 201 of the power receiving apparatus 200 face each other, and the axes thereof are parallel to the z-axis. As a result, the transmitting coil 102-1 and the receiving coil 201 can be firmly electromagnetically coupled (hereinafter simply referred to as coupled) with each other, thereby to achieve wireless power transmission from transmitting coil 102-1 to the receiving coil 201.

In contrast, transmitting coil 102-2 provided on the side surface of the housing 101 has its axis parallel to the y-axis while the axis of the receiving coil 201 is parallel to the z-axis. Therefore, the coil axes are perpendicular to each other. Accordingly, transmitting coil 102-2 and the receiving coil 201 are not coupled.

Similarly, when the power receiving apparatus 300 shown in FIG. 3 is inserted into the housing 101 in the wireless power transmission apparatus 100, the axes of transmitting coil 102-2 and the receiving coil 301 are then parallel to each other, and are therefore mutually coupled, thereby to allow wireless power transmission. In contrast, transmitting coil 102-1 and the receiving coil 301 are not coupled.

When the axes of the two transmitting coils are made perpendicular to each other, high power transmission efficiency can be achieved for both of the power receiving apparatuses that have respective coil axes parallel to the x- and y-axes. Therefore, when there are two transmitting coils, axes thereof are desirably made perpendicular to each other. However, even when the axes of the two transmitting coils are not perpendicular to each other, wireless power transmission is possible in certain cases. That is, insofar as the axes of at least two transmitting coils are different, i.e., arranged to be not parallel to each other, wireless power transmission is possible to any power receiving apparatus that is oriented in any way. However, in this case, power transmission efficiency deteriorates.

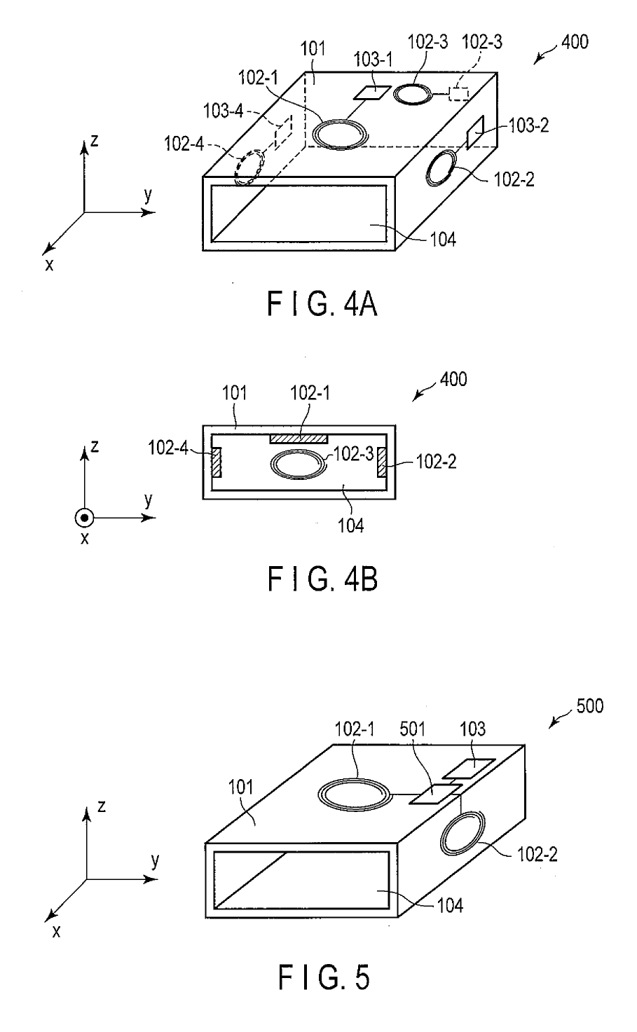

Next, an example of providing three or more transmitting coils will be described with reference to FIGS. 4A and 4B. As in FIGS. 1A and 1B, FIG. 4A is a perspective view of a wireless power transmission apparatus 400, and FIG. 4B is a plan view along the x-axis.

FIGS. 4A and 4B show a case that four transmitting coils 102 (102-1 to 102-4) are provided. When three or more transmitting coils 102 are provided, the axes of three of the plurality of transmitting coils 102 may be arranged to be perpendicular to one another. In the example of FIG. 4, the axis of a transmitting coil 102-1 is parallel to the z-axis. The axes of transmitting coils 102-2 and 102-4 are parallel to the y-axis. The axis of a transmitting coil 102-3 is parallel to the x-axis. In this arrangement, high power transmission efficiency can be achieved for a power receiving apparatus including receiving coils whose axes are respectively parallel to the x-, y-, and z-axes. The remaining transmitting coil 102 may have any orientation.

According to the first embodiment as described above, the axes of at least two transmitting coils are arranged to differ from each other, and therefore, wireless power transmission can be achieved regardless of the orientation of a receiving coil of a power receiving apparatus. Accordingly, the degree of freedom about where the power receiving apparatus is placed in the housing can be increased, and wireless power transmission to various power receiving apparatuses can be achieved easily.

### Second Embodiment

A difference from FIG. 1 showing transmitting circuits respectively connected to transmitting coils to supply power is that wireless power transmission is performed by switching transmitting coils to which power is transmitted from a transmitting circuit provided at a place.

A wireless power transmission apparatus according to the second embodiment will now be described with reference to FIG. 5.

A wireless power transmission apparatus 500 according to the second embodiment includes a housing 101, transmitting coils 102-1 and 102-2, a switch circuit 501, and a transmitting circuit 103.

The switch circuit 501 receives power from the transmission circuit 103, and switches to supply power to a transmitting coil which is to perform wireless power transmission. In this manner, transmission circuits need not respectively be provided for all transmitting coils, and a transmitting coil to perform wireless power transmission can be selected while an entire circuit scale is reduced. The wireless power transmission apparatus 500 may include a plurality of switch circuits.

Specifically, for example, it is supposed that a user knows the orientation of a power receiving apparatus placed by the user. At this time, if a user switches power supply by the switch so as to transmit power from a transmitting coil which faces the receiving coil, wireless power transmission can be performed efficiently with wasteful power consumption suppressed.

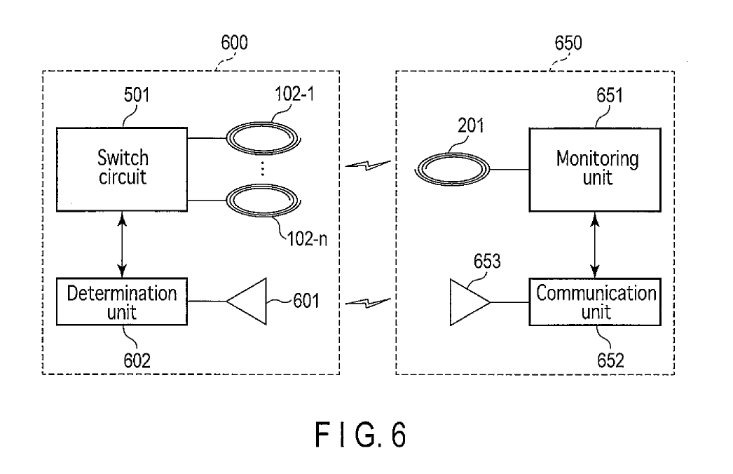

Further, power supply may be switched based on transfer efficiency of power from the transmitting coils. FIG. 6 shows a block diagram as an example of the wireless power transmission apparatus where power supply is switched based on power transmission efficiency.

As shown in FIG. 6, a power receiving apparatus 650 includes a receiving coil 201, a monitoring unit 651, communication unit 652, and a communication antenna 653. Further, a wireless power transmission apparatus 600 includes a plurality of transmitting coils 102-1 to 102-n (where n is a natural number not smaller than 2), a switch circuit 501, a communication antenna 601, and a determination unit 602.

The monitoring unit 651 monitors power received by the receiving coil 201, and measures a received power value.

The communication unit 652 receives the received power value from the monitoring unit 651, and transmits the value to the wireless power transmission apparatus 600 through the communication antenna 653.

The communication antenna 653 may be a commonly used antenna which is used for data communication, and may have the same shape as the transmission coil 102 and the receiving coil 201.

The communication antenna 601 is the same as the communication antenna 653 of the power receiving apparatus 650, and a description thereof will be omitted herefrom.

The determination unit 602 receives the received power value from the power receiving apparatus 650 through the communication antenna 601, and calculates transmission efficiency from a ratio between the transmission power value and the received power value. The determination unit 602 determines whether or not the transmission efficiency is not greater than a threshold value. The determination unit 602 instructs the switch circuit 501 to switch the transmitting coils 102 if the transmission efficiency is not greater than the threshold value.

The switch circuit 501 switches the transmitting coils 102 in accordance with the instruction from the determination unit 602. In this manner, a transmitting coil 102 which achieves excellent transmission efficiency can be appropriately be selected from the plurality of transmission coils 102.

By repeating operations as described above, a transmitting coil which can perform most efficient wireless power transmission can be detected.

According to the second embodiment as described above, a transmitting coil having excellent transmission efficiency can be appropriately selected for a power receiving apparatus, and wireless power transmission can be efficiently achieved.

### Third Embodiment

The third embodiment differs in that a number of transmitting coils connected to a switch circuit is limited. If all connections to the transmitting coils are made by a switch circuit, the switch circuit needs to have a complex configuration. If the number of connectable transmitting coils is reduced, the switch circuit can have a simplified configuration.

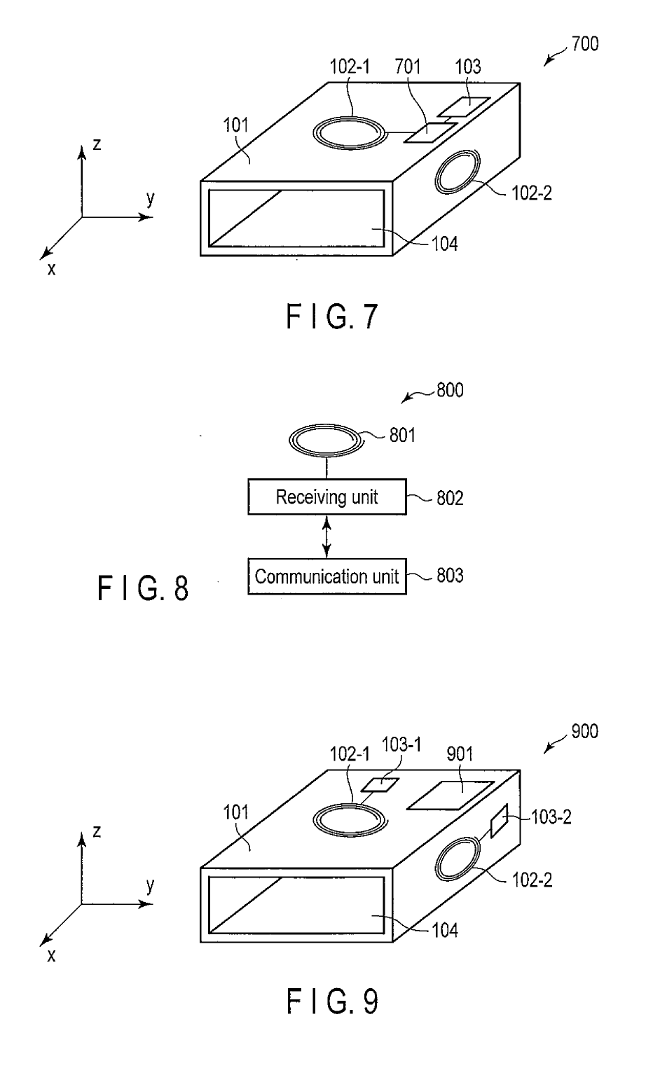

A wireless power transmission apparatus according to the third embodiment will be described with reference to FIG. 7.

The wireless power transmission apparatus 700 includes a housing 101, transmitting coils 102-1 and 102-2, a switch circuit 701, and a transmitting circuit 103.

The switch circuit 701 restricts at least one of the transmitting coils 102 from being connected to the transmitting circuit 103, among the transmitting coils 102 provided in the wireless power transmission apparatus 700.

In this case, power is not directly transmitted from the transmission coil 102 not connected to the switch circuit 701. At first, a transmission coil 102 connected by the switch circuit 701 is coupled with the transmitting coil 102 not connected to the switch circuit 701. Thereafter, the transmission coil 102 not connected to the switch circuit 701 functions to relay power without loosing energy. Accordingly, the power is wirelessly transmitted to a power receiving apparatus. As a result, substantially the same effects as obtained by the switch circuit connected to all the transmitting coils can be obtained.

At least one of conditions 1 and 2 below need to be satisfied as conditions for wirelessly transmitting power from a transmitting coil 102 connected to the switch circuit 701 and for coupling with a transmitting coil 102 not connected to the switch circuit 701.

Condition 1: Axes of transmitting coils connected and not connected to the switch circuit 701 may not be perpendicular to each other.

Condition 2: Any transmitting coil which is not connected to the switch circuit 701 may not exist on a projection of the axis of a transmitting coil connected to the switch circuit 701.

According to the third embodiment described above, wireless power can be transmitted to a power receiving apparatus placed in an arbitrary position, with a scale of a circuit configuration reduced.

### Modification to First to Third Embodiments

The present modification supposes that wireless power transmission is performed to a signal receiving apparatus including a power receiving apparatus and a communication unit which makes external communication.

The signal receiving apparatus according to the modification will be described with reference to FIG. 8.

A signal receiving apparatus 800 according to the modification includes a receiving coil 801, a receiving unit 802, and a communication unit 803. The receiving coil 801 and receiving unit 802 operate in the same manner as in the foregoing power receiving apparatus 200 or 300, and receive power from a wireless power transmission apparatus.

The communication unit 803 communicates data through a particular frequency band. The communication unit 803 may include an antenna and may transmit/receive data, or may share a receiving coil and may transmit/receive data by using the shared receiving coil 801.

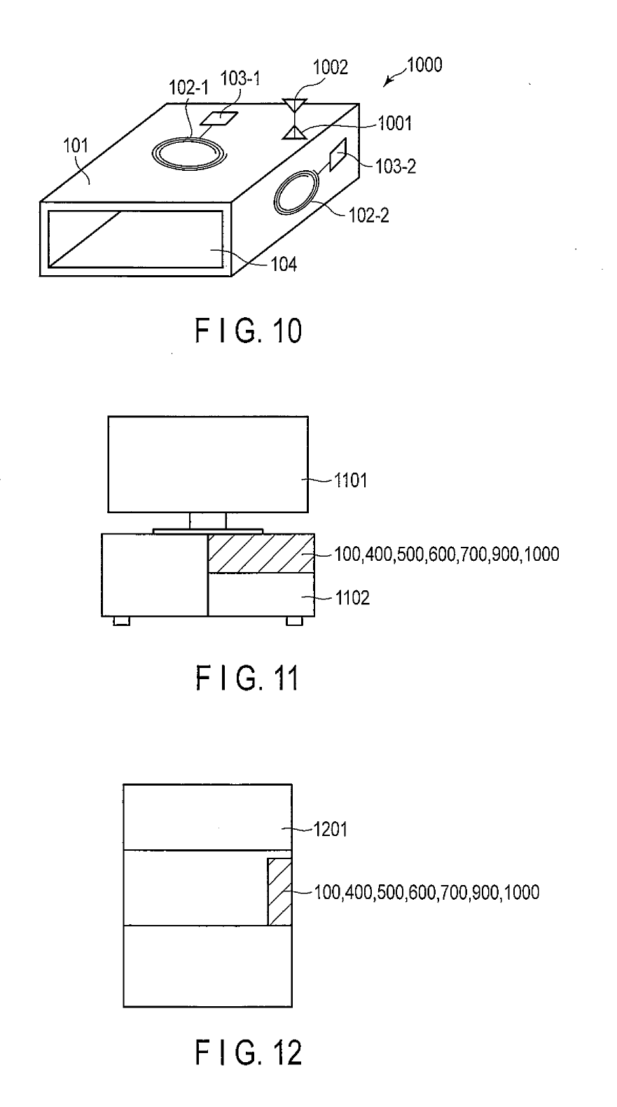

Next, a wireless power transmission apparatus according to the modification will be described with reference to FIG. 9. FIG. 9 will be described with reference to the wireless power transmission apparatus 100 according to the first embodiment as an example, which may be substituted with any of the wireless power transmission apparatuses according to the first to third embodiments.

A wireless power transmission apparatus 900 according to the modification includes a housing 101, transmitting coils 102, transmitting circuits 103, and a frequency-selective window 901.

The frequency-selective window 901 is provided at a part of the housing 101, and allows electromagnetic radiation of an arbitrary frequency to pass. For example, the frequency-selective window 901 is formed by positioning patches or slots cyclically. For example, when the frequency-selective window 901 is formed of patches, a window (opening) is provided in a part of the housing 101, and patches made of a conductor may be arrayed cyclically in a manner that the patches are adjusted in size and in quantity to match a frequency used for part of the opening.

If a frequency used for wireless power transmission and the frequency allowed to pass the frequency-selective window 901 are designed to differ from each other, electromagnetic radiation for wireless power transmission can be prevented from leaking to the outside.

Further, an antenna may be provided inside or outside the housing, in place of the frequency-selective window 901.

Another example of the modification will be described with reference to FIG. 10.

A wireless power transmission apparatus 1000 according to the another example of the modification includes a housing 101, transmitting coils 102, a first antenna 1001, and a second antenna 1002.

The first antenna 1001 is provided inside the housing 101, and transmits electromagnetic radiation received from a signal receiving apparatus 800 to the second antenna 1002. Also, the first antenna 1001 transmits electromagnetic radiation received from the second antenna 1002 to the signal receiving apparatus 800.

The second antenna 1002 is provided outside the housing 101, and radiates electromagnetic radiation received from the first antenna 1001 to outside. The second antenna 1002 also transmits received electromagnetic radiation to the first antenna 1001. By the first antenna 1001 and the second antenna 1002, the same effects as obtained by the frequency-selective window 901 can be obtained.

If a transparent material is used for the housing 101, a state of the signal receiving apparatus such as an incoming alert lamp can be checked visually.

Further, a temperature sensor may be provided in the housing of the wireless power transmission apparatus, so as to stop wireless power transmission from a transmitting coil when a predetermined temperature is reached. In this manner, increase in temperature of the apparatus can be suppressed, and breakdown of elements due to excessive charging can be suppressed.

Further, a weight meter may be provided inside the housing of the wireless power transmission apparatus, and wireless power transmission may be started when a value indicated by the weight meter exceeds a threshold value for a constant period. In this manner, if only a power receiving apparatus is inserted into the housing, wireless power transmission is then started. Accordingly, wireless power transmission can be performed easily without causing a user to perform any other process, such as pressing on a switch to start power transmission.

Now, use examples of the wireless power transmission apparatus will be described with reference to FIGS. 11, 12, and 13.

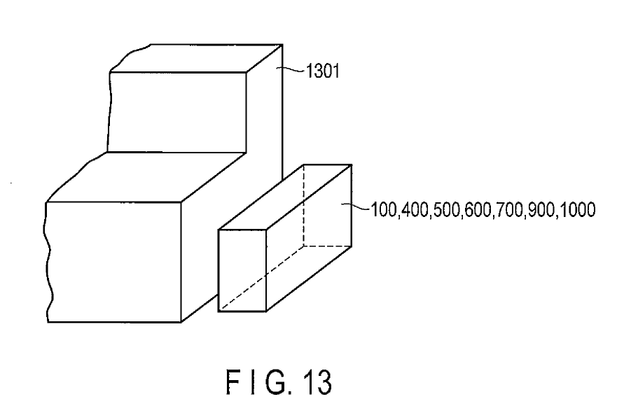

FIG. 11 shows a wireless power transmission apparatus built in a TV table. The wireless power transmission apparatus may be built in and arranged in a TV table 1102 where a TV 1101 is placed, in a manner that an opening of the wireless power transmission apparatus faces the front. FIG. 12 shows an example in which a wireless power transmission apparatus is mounted in a shelf 1201, and may be positioned in a manner that an opening is oriented so as to allow easy insertion and pulling out for users. FIG. 13 shows a wireless power transmission apparatus provided in parallel with a side of a sofa 1301. If an opening of the wireless power transmission apparatus is oriented upward, users can easily insert a power receiving apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless power transmission apparatus, comprising:
a housing capable of containing one or more power receiving apparatuses comprising one or more receiving coils which receive power; and
a plurality of transmitting coils provided inside the housing and configured to transmit the power to the power receiving apparatuses by making electromagnetic coupling with the receiving coils, at least two of the plurality of transmitting coils having orientations of axes different from each other, the axes each indicating a line perpendicular to a plane which is defined by windings of a coil.

2. The apparatus according to claim 1, wherein the housing comprises a partial area formed of a conductor, the partial area being a region where the transmitting coil is orthogonally projected on surfaces of the housing and nearest to the transmitting coil, the surfaces intersecting with an extended line of a axis of the transmitting coil.

3. The apparatus according to claim 1, wherein the at least two of the plurality of transmitting coils have axes perpendicular to each other.

4. The apparatus according to claim 1, wherein three of the plurality of transmitting coils have axes perpendicular to one another.

5. The apparatus according to claim 1, further comprising one or more switch circuits configured to switch a power supply to at least one of target transmitting coils among the plurality of transmitting coils, the target transmitting coils indicating targets which are to be supplied with the power.

6. The apparatus according to claim 5, further comprising a determination unit configured to determine whether or not transmission efficiency of the power is not greater than a threshold value, wherein if the determination unit determines the transmission efficiency to be not greater than the threshold value, at least one of the switch circuits switch the power supply to the target transmitting coils.

7. The apparatus according to claim 5, wherein if the plurality of transmitting coils comprise a first transmitting coil connected to one of the switch circuits, and a second transmitting coil failed to connect to the switch circuits, the second transmitting coil satisfies at least one of conditions that axis of the first transmitting coil and axis of the second transmitting coil are not perpendicular to each other, and that the second transmitting coil fails to be positioned on a projected axis of the first transmitting coil.

8. The apparatus according to claim 1, wherein if wireless power transmission is performed to a signal receiving apparatus comprising at least one of the receiving apparatuses and a communication unit configured to perform data communication according to a frequency band, one or more windows are designed in the housing in accordance with the frequency band to allow the signal receiving apparatus to communicate with outside of the housing.

9. The apparatus according to claim 1, further comprising, if wireless power transmission is performed to a signal receiving apparatus comprising at least one of the receiving apparatuses and a communication unit configured to perform data communication according to a frequency band,
a first antenna connected to an inner surface side of the housing and by which the signal receiving apparatus performs communication through; and
a second antenna connected to an outer surface side of the housing, receives a signal transmitted from the second antenna, and transmits the signal to outside.
